(19) United States
(12) Patent Application Publication
(10) Pub. No.: US 2015/0336297 A1
(43) Pub. Date: Nov. 26, 2015

(54) FORMWORK FOR ARCHITECTURAL APPLICATIONS AND METHODS

(71) Applicant: KENT STATE UNIVERSITY, Kent, OH (US)

(72) Inventor: Brian P. Peters, Kent, OH (US)

(21) Appl. No.: 14/718,144

(22) Filed: May 21, 2015

Related U.S. Application Data
(60) Provisional application No. 62/001,949, filed on May 22, 2014.

(51) Int. Cl. B29C 33/38; B29C 33/40; B29C 67/00

(52) U.S. Cl. CPC B29C 33/3842; B29C 67/0055; B29C 33/40; B33Y 10/00

(57) ABSTRACT

This invention relates to three-dimensional printed formwork for architectural applications for example, such as in producing precast or cast products. The system and methods for producing a form for casting of a three dimensional object comprising converting a geometry of the three-dimensional image or design of a form for casting of a three dimensional object to a format that is compatible with a three-dimensional printer. The form is printed from a printing material using a three dimensional printer.

### CROSS-REFERENCE TO RELATED APPLICATIONS/INCORPORATION BY REFERENCE

This patent application claims priority to and the benefit of U.S. Provisional Patent Application Ser. No. 62/001,949 filed on May 22, 2014, which is incorporated herein by reference in its entirety.

### FIELD OF THE INVENTION

This invention relates to 3D printed formwork for architectural applications, such as precast concrete products, and methods of making and using such forms.

### BACKGROUND AND SUMMARY

Cast concrete is used to form products useful for many applications, such as precast construction products produced by casting concrete in a mold or form, in which the concrete is cured in a controlled environment, and then transported to the construction site and positioned into place. Precast concrete products are formed of concrete (a mixture of cement, water, aggregate and often admixtures) that is poured into a form or mold, typically made of wood or steel. It is then cured in a controlled environment before being stripped from the form, typically the following day. This process is completed at a location other than its final in-service position, and the final casts are then transported to the construction site for erection into place. Standard formwork is time and material intensive to construct and deconstruct for each form cast. Alternatively, the concrete may be poured into site-specific forms and cured on site. Other precast materials include precast stone which uses a fine aggregate in the mixture, so the final product approaches the appearance of naturally occurring rock or stone. By producing precast concrete in a controlled environment (typically referred to as a precast plant), the precast concrete is afforded the opportunity to properly cure and be closely monitored by plant employees. Utilizing precast concrete products may offer many potential advantages over site casting of concrete for various applications, and it would be advantageous to enhance the ability to manufacture precast concrete products having unique configurations and appearances. Also, the ability provide formwork at a construction site to impart desired aesthetics to cast concrete or like materials would be desirable. Precast products may include building and site amenity products, agricultural products, retaining walls, sanitary and storm water management products, transportation related products, water or wastewater products, paving products, marine products, hazardous materials containment products for example. It should be evident that the products which may be formed using the cast products are effectively endless.

There have also been efforts at 3D printing large-scale concrete structures, referred to as FDM (fused deposition modeling) or FFF (fused filament fabrication), being an additive manufacturing process commonly used for modeling, prototyping, and production applications. The process works on an “additive” principle by laying down material in layers to produce a part. The technique provided printing directly with concrete based materials. Though such an approach may be suitable for forming prefabricated structures or the like, it would be desirable to utilize 3D printing techniques at the scale of architecture.

Historically, casting custom textures in concrete relied on creating a mold from an existing object. For example, if a wood grain texture was desired, strips of wood were used as a mold, allowing the concrete to be imprinted with the grain. However, over the more recent past new fabrication techniques have emerged that allow the casting of complex geometries or offer a wide variety of textured finishes for what are usually flat and unadorned surfaces. One of these techniques is the use of CNC milling machines to sculpt the negative of a mold out of foam or other solid material, which is then cast in a flexible material, such as silicon.

The general object of the present invention is to provide a new and improved flexible formwork made using 3D printing techniques. Rather than directly printing building sections in concrete, the flexible formwork of the invention can be 3D printed to cast traditional concrete. Formwork of the invention is lightweight, easy to transport, and can be reused to cast multiple sets and then ultimately recycled and reprinted as a different form, or may be made to dissolve or be self-degradable or bio-degradable. The invention eliminates the step of sculpting a negative cast and thus eliminates material waste, reducing fabrication time and offering greater design flexibility by allowing designers the opportunity to digitally generate any texture.

In an aspect, the invention relates to a method for molding a form for casting of a three dimensional object comprising converting a geometry of the three-dimensional image or design of a form for casting of a three dimensional object to a format that is compatible with a three-dimensional printer. Thereafter, the step of printing the three-dimensional image or design to prepare a three-dimensional form from a printing material using the three dimensional printer. The form may include at least one surface with ornamentation associated therewith. Further, the invention relates to a method for molding a three dimensional precast concrete product comprising converting a geometry of the three-dimensional image or design of a form for casting of a three dimensional object to a format that is compatible with a three-dimensional printer. The three-dimensional image is then printed to prepare a three-dimensional form from a printing material using the three dimensional printer. The form may include at least one surface with ornamentation associated therewith. A curable material is poured into the three-dimensional form, and the curable material is allowed to set and cure in the three-dimensional form. Thereafter, the cured material is separated from the three-dimensional form. In yet another aspect, the invention relates to a form for casting of a product comprising at least one surface for engaging a curable material in a mold, the at least one surface formed of a plastic material having predetermined characteristics to allow moisture to be evacuated from the mold for curing of curable material in the mold. In another aspect, the invention relates to a form for casting of a product comprising at least one surface formed of a dissolvable material for engaging a curable material in a mold, the dissolvable material having predetermined characteristics to allow the curable materials to cure in the mold and then to dissolve to leave the cured material cast into a desired form.

These and other features and advantages of the present invention will be apparent to those of skill in the art in view of the following written description and drawings.

### BRIEF DESCRIPTION OF THE DRAWINGS

FIG. 1 shows a perspective view of an example of a formwork and the cast concrete product formed thereby, according to an example of the invention.

FIGS. 2A-2C show an example of a 3D printing system for producing formwork according to the invention.

FIG. 3 is a view showing formation of textures or other design characteristics in an example formwork of the invention.

FIGS. 4A-4F show use of the formwork of the invention in casting of a product.

FIG. 5 shows an example of a 3D printed form and a cast product formed therefrom.

FIG. 6 shows another example of a 3D printed form and a cast product formed therefrom.

FIG. 7 shows an example of a multi-part 3D printed form and a cast product formed therefrom.

FIG. 8 shows an example of a cast product formed from a 3D printed form according to the invention, with connecting portions formed therein.

FIG. 9 shows another example of a cast product formed from a 3D printed form according to the invention, with connecting portions formed therein.

FIGS. 10-13 show various examples of formwork according to the invention along with cast products produced therefrom.

### DETAILED DESCRIPTION

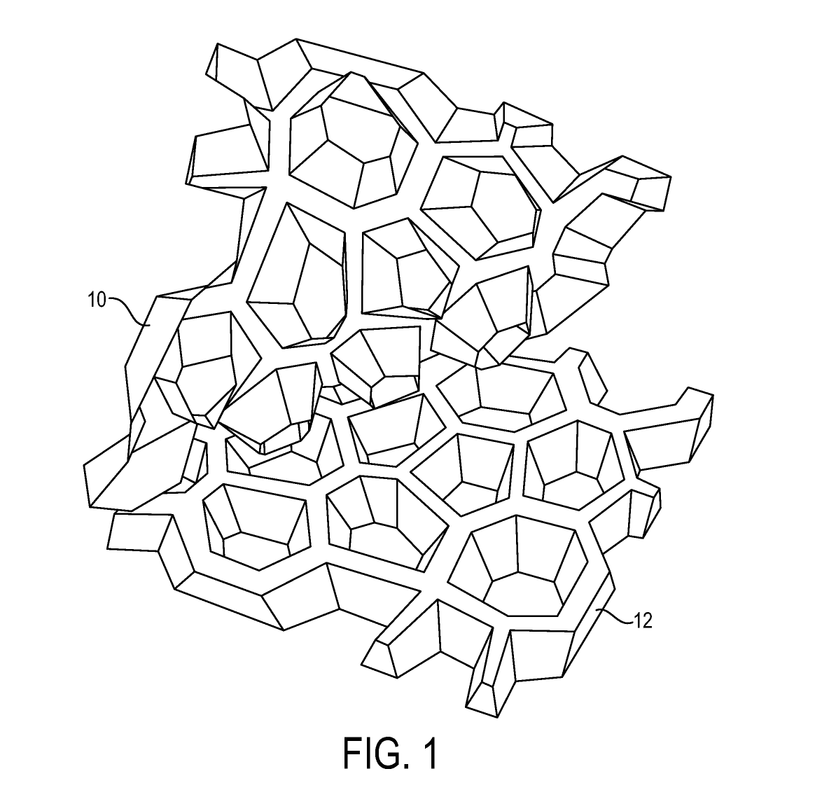

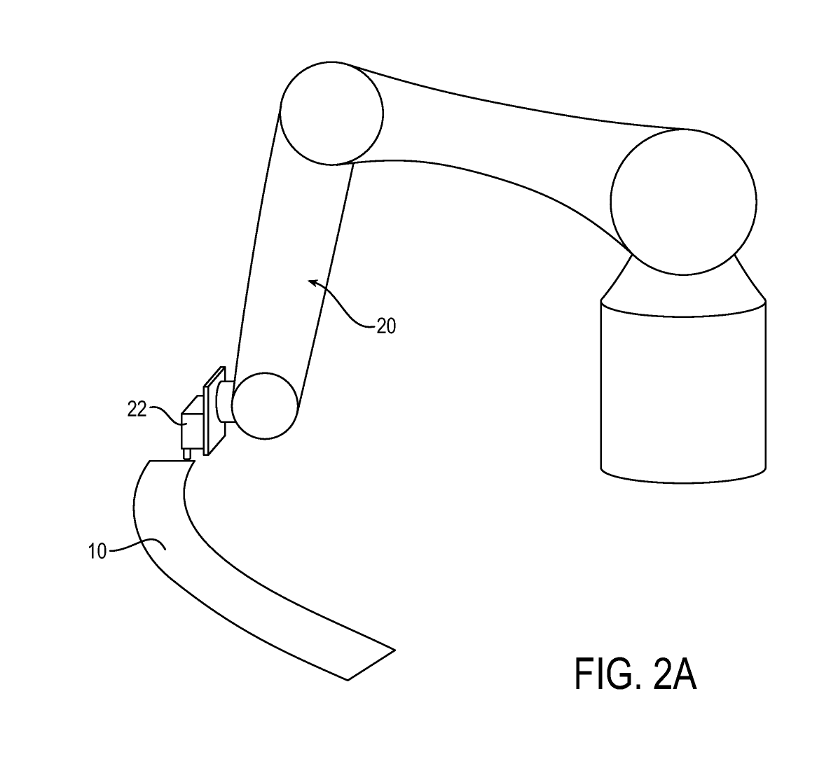

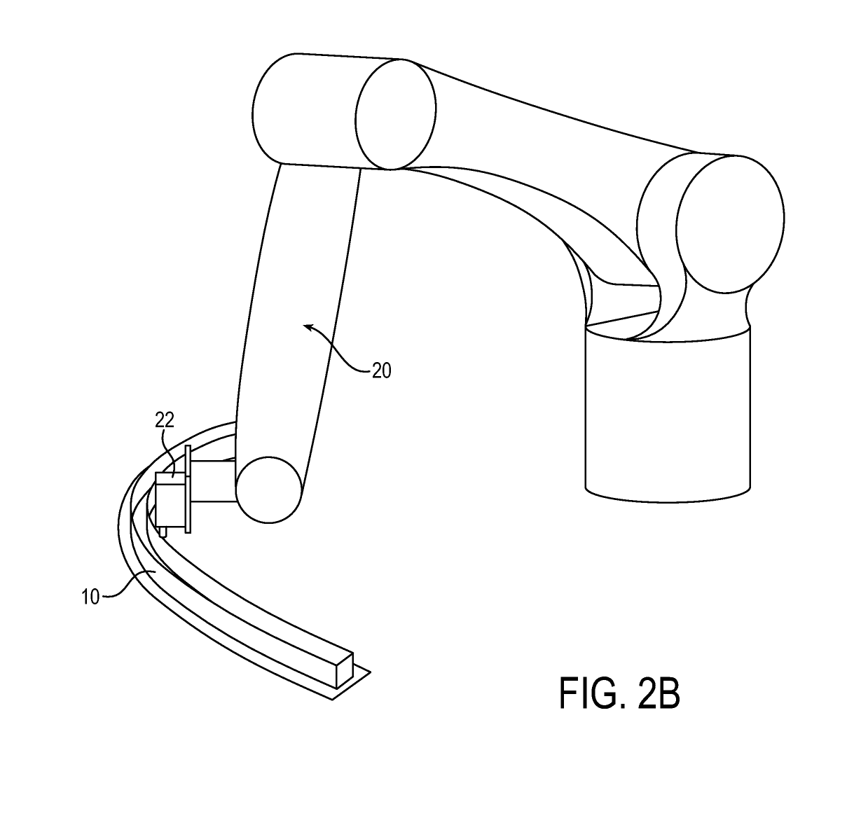

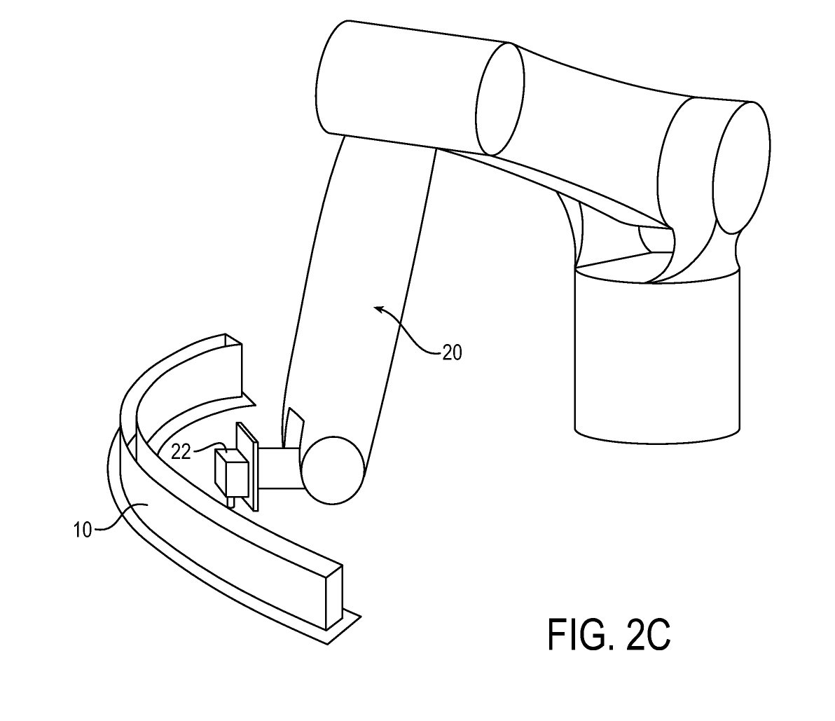

An example of a formwork 10 according to an example of present invention is shown in FIG. 1, along with the concrete (or other suitable material) product 12 produced thereby. The formwork 10 is made of a flexible material to allow it to be easily removed from the cast concrete product 12 after curing of the concrete. To prepare the formwork 10, any suitable 3D printing materials can be used. As an example, flexible polylactic (PLA) plastic filament may be suitable to make formwork according to the invention for various applications. Other suitable materials may be ABS, nylon, EPDM or a variety of other plastic materials that can be used in association with a printing head. In FIGS. 2A-2C, an example of a 3D printing system is shown, which may include a robotic arm 20 having a 3D printing head 22 at its distal end. As can be seen, the movement of the robotic arm and print head may be controlled to form any desired shape and configuration of formwork according to the invention. For other applications, a more traditional 3D printer with a printing stage and print head may be used, or any other 3D printing system. As an aspect, formwork made using PLA is advantageous as compared to standard rigid plastic materials, in that a single formwork can be recast multiple times, with no damage to the mold itself. Rigid forms need to be constructed and then deconstructed, with extensive time and labor costs. Flexible molds hold their form during the casting process, but then allow the concrete to be easily released.

The 3D printing filament used according to the invention may vary depending on the application and/or environment with which the formwork is to be used, and may have varying degrees of flexibility or other physical characteristics as will be described further. For example, depending on the application, the 3D printed formwork according to the invention using PLA have achieved the desired balance of flexibility and structural integrity to eliminate or limit distortions or unconformities. Further, the materials and fabrication process are controlled to produce concrete formwork that is not necessarily producing a water tight mold, but a mold that has a predetermined porosity and/or permeability, or ability to evacuate moisture as the concrete cures, to allow water or water vapor to slowly seep through the bottom and/or sides of the formwork, drying or curing the concrete at the desired rate.

The formwork 10 of the invention may be used with traditional concrete mixtures that have no additives or composite materials, or such additives or composite materials may be used to increase the performance or aesthetic of the concrete. For example, pigments are many times used in precast products to yield a unique appearance, which is enhanced by the formwork of the invention. Chemical additives may be added to the concrete to give it certain characteristics not obtainable with plain concrete mixes. Additives may be use in amounts such as about or less than 5% by mass of cement and may be added to the concrete at the time of batching/mixing. Such additives may include accelerators to speed up the hydration or hardening of the concrete. Such materials may include CaCl₂, Ca(NO₃)₂ and NaNO₃ for example. Another additive may include retarder that instead slow the hydration of concrete and are used in large or difficult pours where partial setting before the pour is complete is undesirable. Such materials may include polyols such as glucose, sugar, sucrose, tartaric acid and sodium gluconate. For some applications, it may be desirable to add plasticizers that may increase the workability of the “fresh” concrete, allowing it be molded more easily. A typical plasticizer is lignosulfonate for example. Plasticizers can also be used to reduce the water content of a concrete while maintaining workability. There are also superplasticizers such as sulfonated naphthalene formaldehyde condensate, sulfonated melamine formaldehyde condensate, acetone formaldehyde condensate and polycarboxylate ethers. In other applications, additives may provide for air entrainment to add and entrain tiny air bubbles in the concrete, which reduces damage during freeze-thaw cycles, increasing durability. In some applications, for strength, steel rebar or other reinforcement may be used, and corrosion inhibitors may be used to minimize the corrosion of steel and steel bars in concrete. Bonding agents may be used to create a bond between old and new concrete (typically a type of polymer) with wide temperature tolerance and corrosion resistance, and pumping aids improve pumping ability and thicken the paste and reduce separation and bleeding. Other inorganic materials may be used, such as materials that have latent hydraulic or other properties to increase strength or other characteristics, such as limestone, fly ash, silica fume, high reactivity metakaolin (HRM), blast furnace slag or the like.

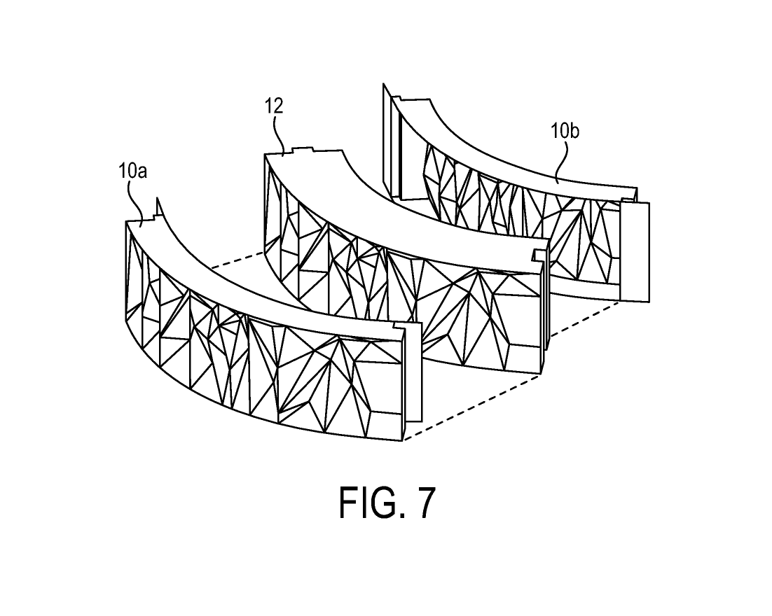

For example, materials such as Glass Fiber Reinforced Concrete (GFRC) and Ultra High Performance Concrete (UHPC) may provide advantages in use with the formwork, allowing the formwork to be used to create high definition precast products, or precast products having structural integrity for a desired application. These materials offer for example, the potential of creating thin, detailed precast panels using the formwork of the invention, that have structural integrity without additional reinforcement. These materials may also be best suited to flexible molds, that put some stress on the material as the mold is carefully removed. Such materials may further allow for interconnecting male and female structures to be easily formed in the cast materials, such as shown in the examples of cast blocks as in FIG. 7.

As an example, the 3D printed formwork of the invention may be created using a parametric design model, allowing the quick set-up of a series of design and fabrication parameters. These could relate to site-specific environmental performance data or structural requirements and be easily modified and adjusted for each print, allowing for unique molds with minimal labor. The method of designing and/or controlling the 3D printing process may be any suitable system or approach.

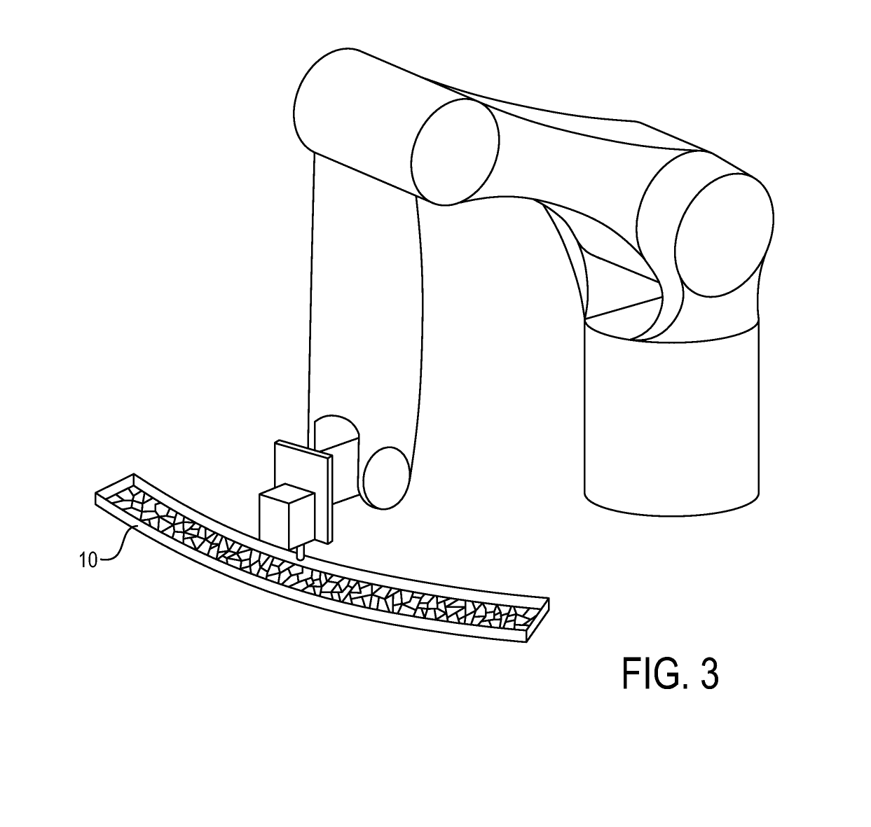

As an example, geometry for the creating formwork according to examples was developed within Rhino's parametric scripting language, Grasshopper™. The initial step of the Grasshopper™ definition defined the overall form of the application (e.g. wall panel) by inputting the design parameters of the desired structure. The final part of the Grasshopper™ definition is a custom script that translates the desired three dimensional model of a formwork into g-code for a 3D printer, 6-axis robot arm as shown in FIG. 2 or other suitable apparatus. The Kuka PRC™ plugin was used to simulate the movements of, and generate the code of the tool path specifically for the robot arm shown in FIG. 2 for example. Therefore, a master Grasshopper™ script includes all the information needed for the formwork, ranging from the design, to a simulation of the printing process and finally to the fabrication code. This minimizes the time spent redesigning and modifying the molds based on the material to be used and the desired physical characteristics of the formwork. As an example, using the 6-axis robot arm as shown in FIG. 2, the formwork may be provided with any desired pattern or ornamentation as shown in FIG. 3. As can be seen in FIGS. 2A-2C, the formwork 10 may be produced using the PSA or other suitable materials as described above.

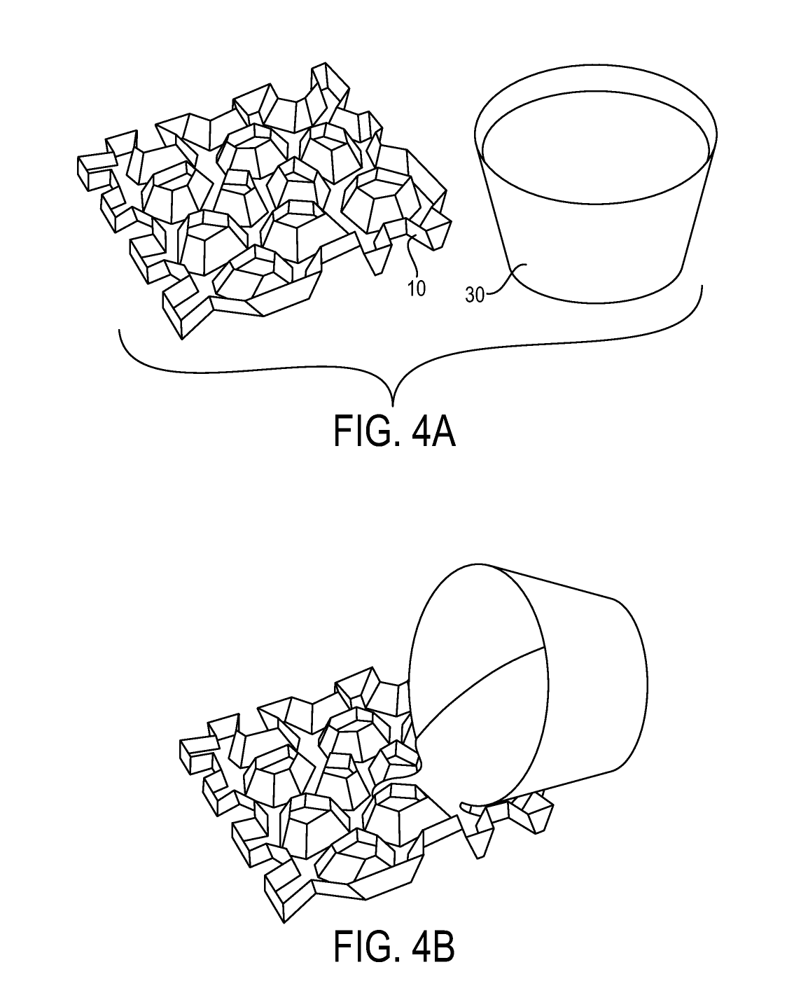

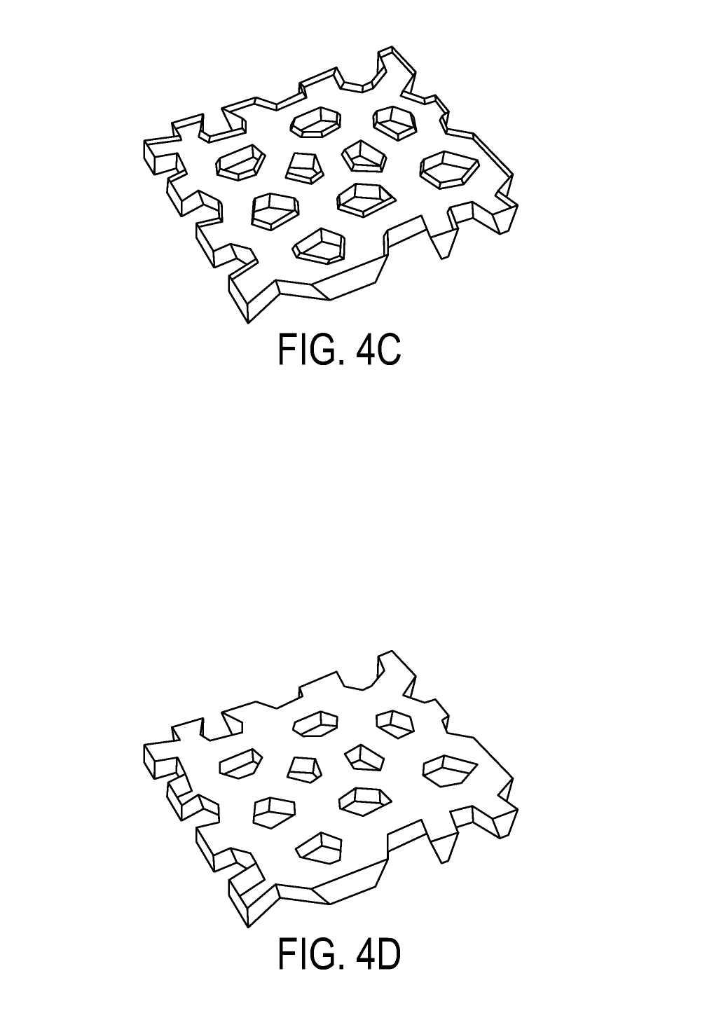

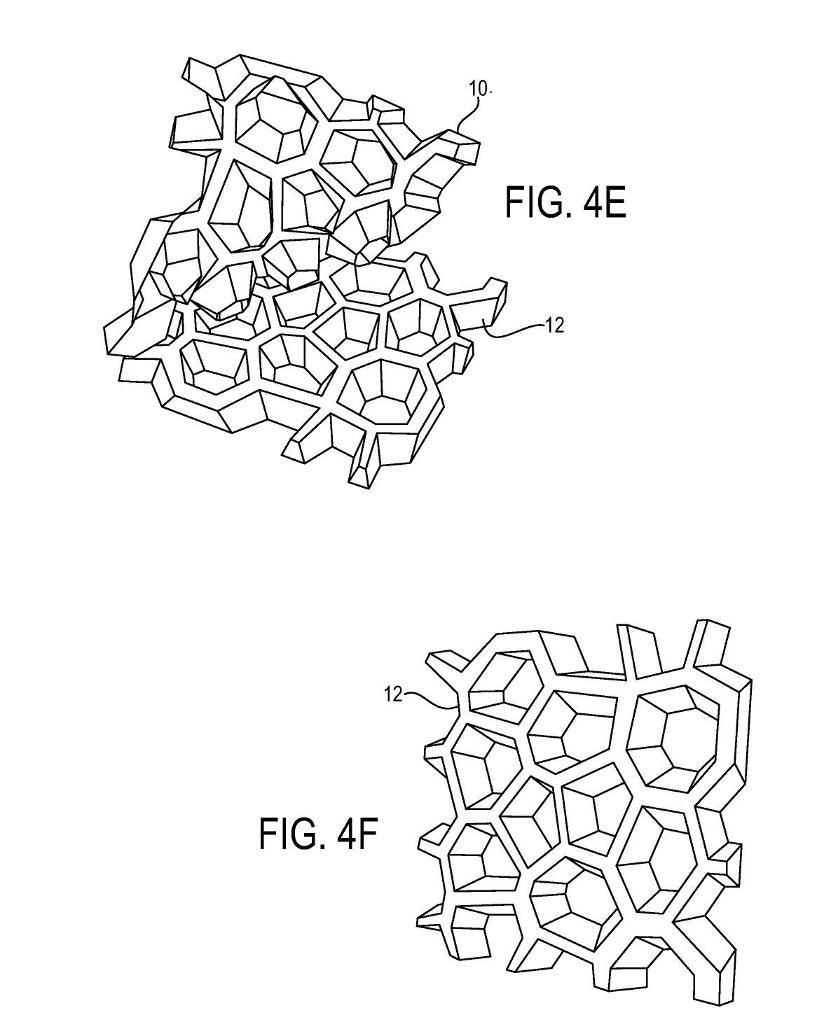

With reference to FIGS. 4A-4F, a simplified fabrication process for making a precast product includes a first step of 3D printing the flexible formwork 10. Depending on the particular precast product to be formed, the 3D printing system may be of any proper scale to make formwork of a desired size and configuration. After the 3D printing is complete, a release agent 30 is applied to the mold, and then the concrete is mixed, poured, and left to cure in the mold as shown in FIGS. 4B-4D. Once the concrete is set, the flexible mold is simply removed as shown in FIG. 4E and is ready for another casting, while the precast product 12 is ready for use as seen in FIG. 4F.

In preparing the formwork 10 according to the invention, factors such as structural stability, permeability, printing speed, and surface delineation can be controlled depending on the product or application. For example, for larger products, the formwork can be subdivided to allow precise formation of the cast materials without warping or deformation. The materials and thickness can be controlled to create a stiffer wall surface during the casting process if desired, to maximize the efficiency of the wall thickness to reduce the quantity of material and total printing time.

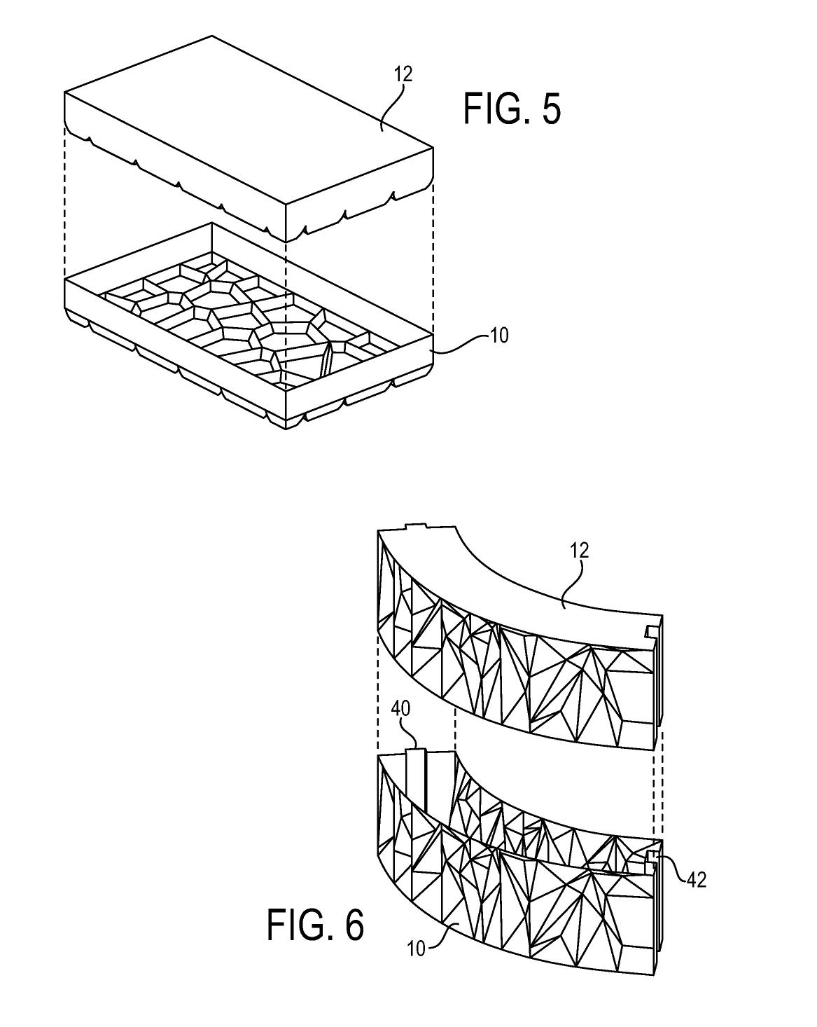

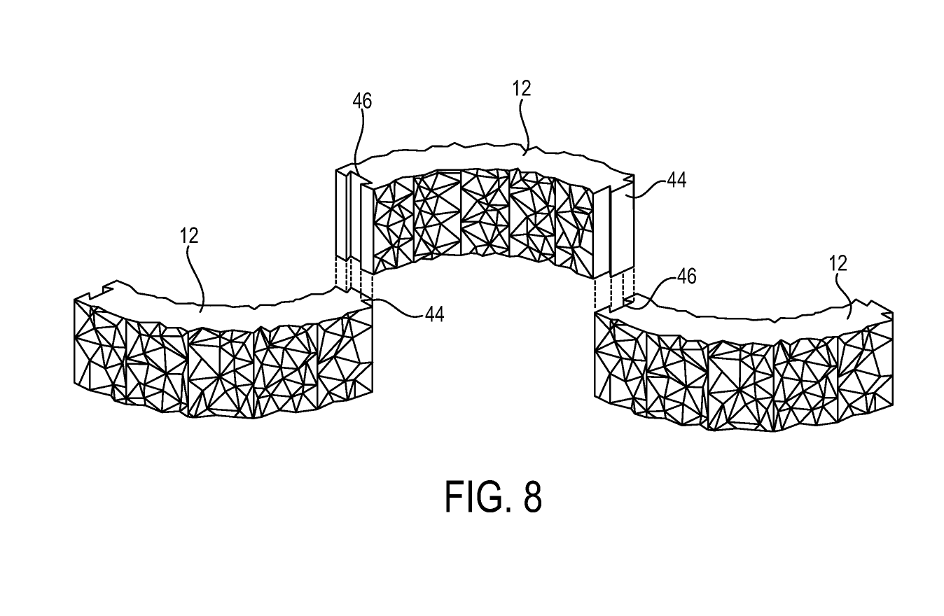

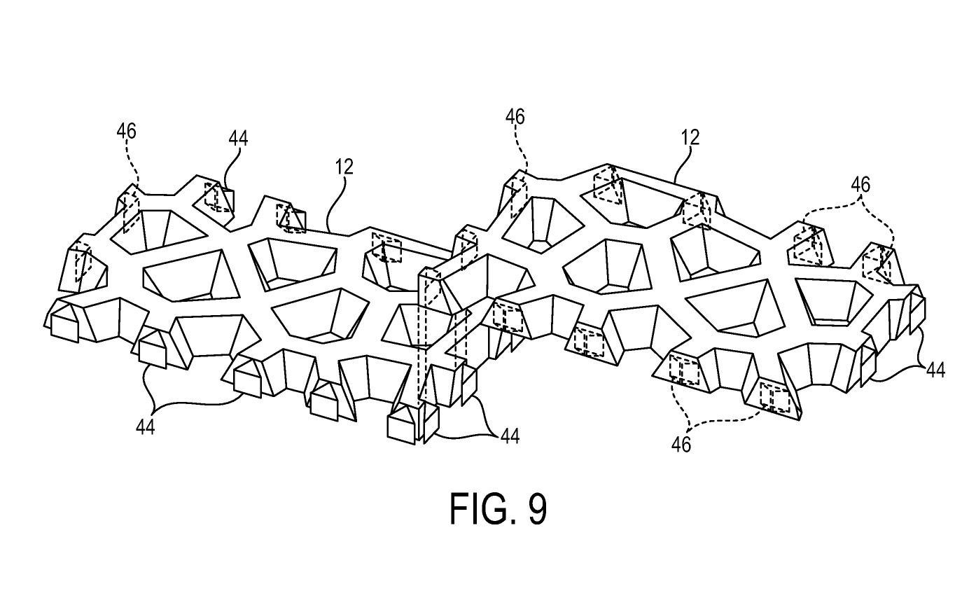

To provide examples of possible formwork according to the invention, products may include blocks or wall panels as just several possibilities. The block construction products may be used as articulated building blocks with both horizontal and vertical orientations for example. As the size of the formwork increases, additional bracing may need to be incorporated in the design to withstand the gravitational forces created by the concrete during the casting process. The wall panels, which include both solid and perforated panels, may be provided with surface treatments and effects that are meant to be exposed in architectural applications. The formwork or molds of the invention may be used as liners placed inside larger wooden or other frames. The use of high performance concrete materials (UHPC and GFRC) with such products may allow for the fabrication technique to take advantage of these high performance concrete materials, since 3D printing can print the formwork 10 in high definition. It should be recognized that the formwork 10 may be designed and implemented as single molds, or two or more-part molds to cast more complex geometries with greater dimensionality. As seen in FIGS. 5-13, various block and wall products are shown as examples, and it should be clear that the variety of such products and the extension to the many other types of cast products that can be formed is endless. As seen in FIG. 5 for example, a cast wall product 12 may be formed using a flexible form 10 having at least one wall with ornamentation formed in association therewith. In FIG. 6, a block product 12 is formed from a form 10 having at least one wall with ornamentation formed in association therewith. It is noted that in the form 10 in the example of FIG. 6, there is integrated connecting portions 40 and 42, such as male female type interlocking connections, which are then integrally formed in the cast product 12 to allow multiple products 12 to be connected together. The interlocking connections between the cast products may include any suitable connection. As an example, each cast product may be formed to have male and female connections (in any permutation) that interlock with adjacent cast products, allowing for quicker and easier assembly in the field. These joints can also be used to create seamless panels by creating panels that snap together to form larger panels. Another example is shown in FIG. 7, wherein the form 10 is constructed of multiple parts 10a and 10b, that together are used to form the cast product 12. Although the form 10 of FIG. 7 is shown in two parts, additional parts may be used to prepare more complex forms as may be desired. As shown in FIG. 8, the cast products 12 may be formed with interlocking structures 44 and 46, such as dovetail connections, to allow products 12 to be connected to each other to form a larger structure. The products 12 shown in the example of FIG. 8 are of block form, but a wall product 12 is shown in FIG. 9 as an alternative. As seen in the example of FIG. 9, the interlocking structures may be formed as male and female portions 44 and 46 that mate to form a hidden dovetail joint for example. Any other suitable joint configurations may also be integrated into the form 10 according to the invention and thereby integrally formed in the cast products formed thereby.

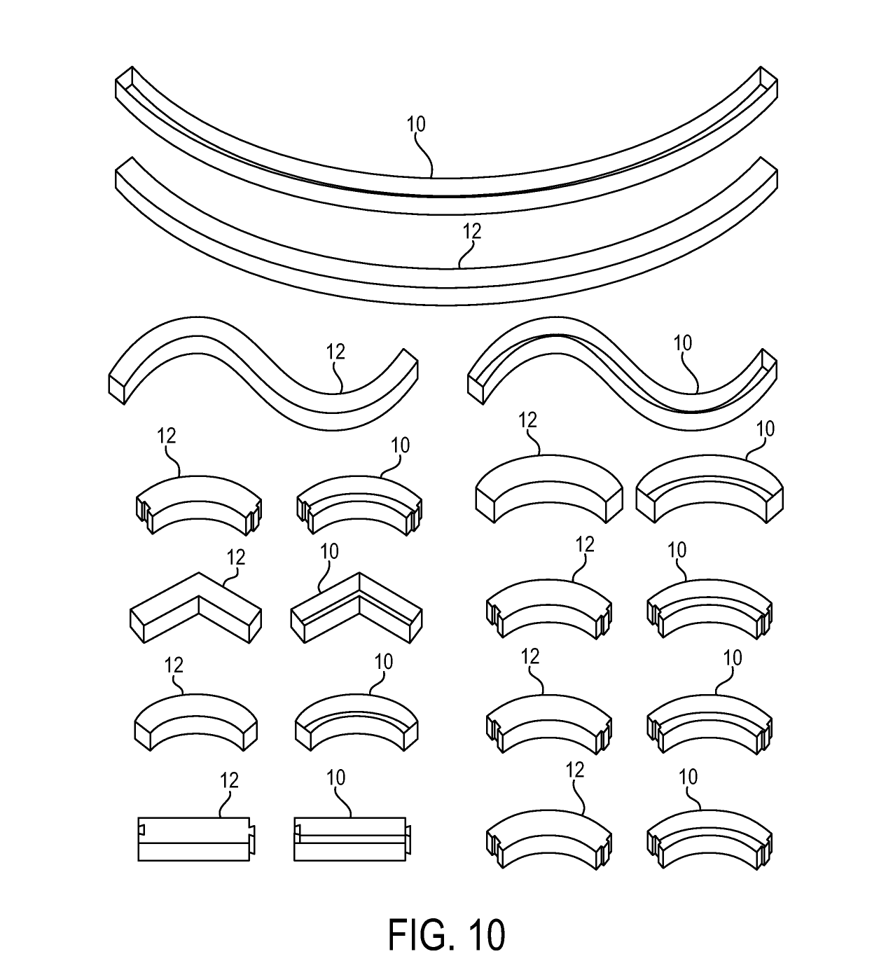

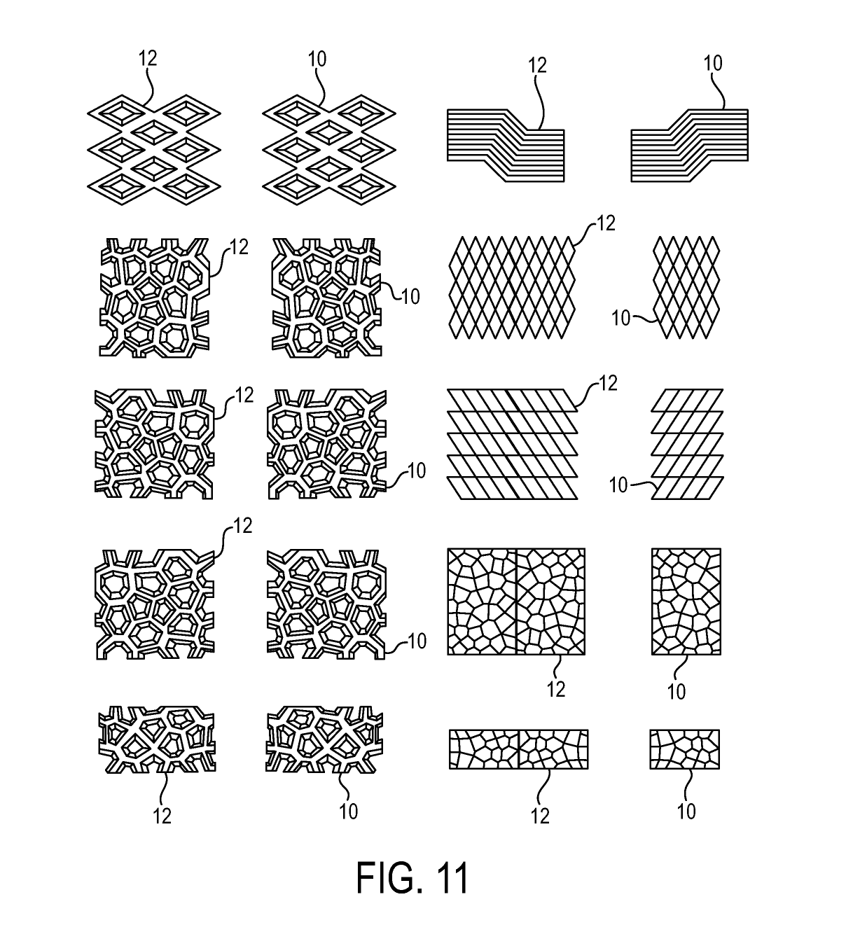

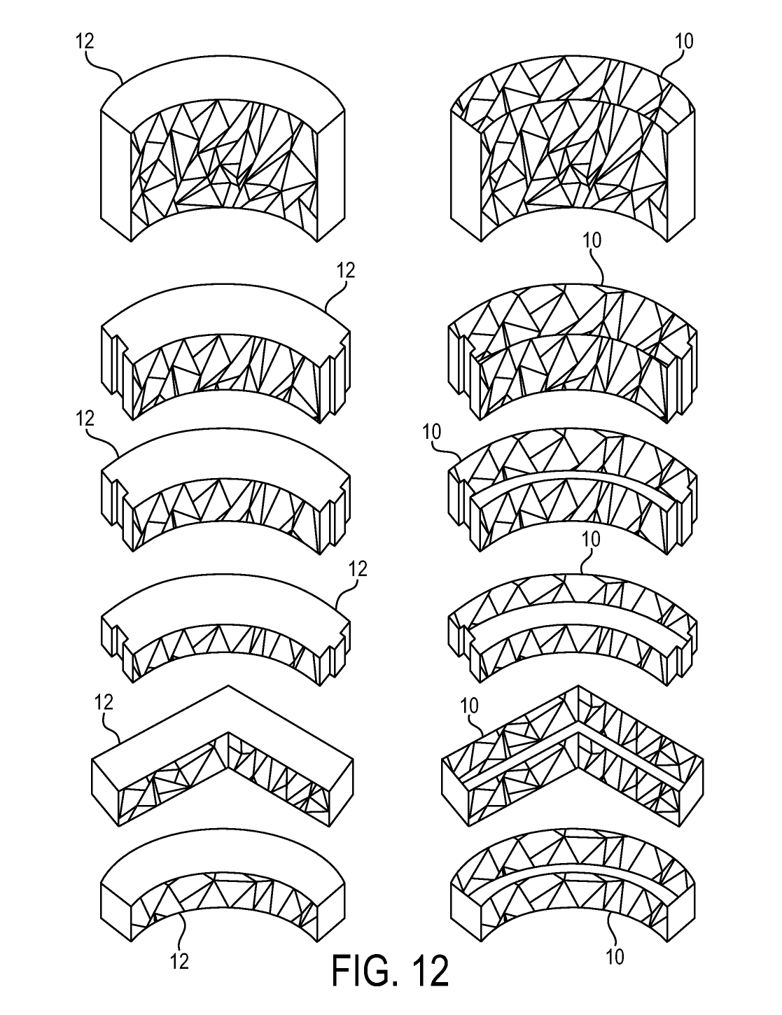

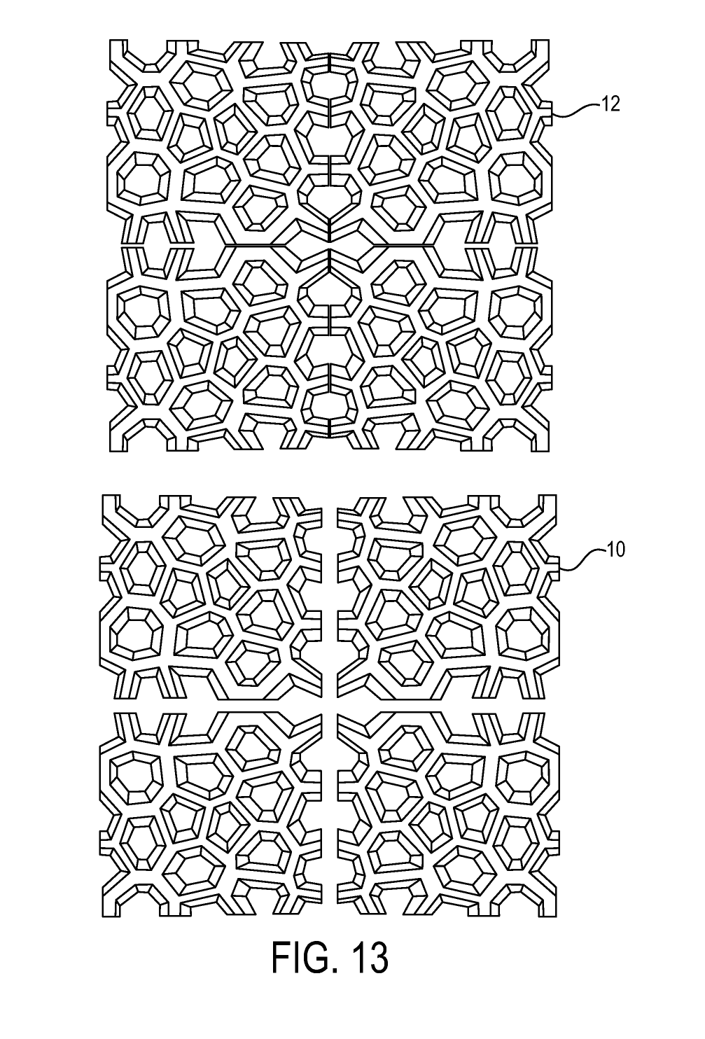

As seen in the examples of FIGS. 10-13, the formwork 10 may be configured in a wide variety of shapes and/or to have ornamentation integrated into the wall(s) to impart such ornamentation to the cast product. As the forms 10 can be made to include multiple sections that interlock or otherwise cooperate with one another to make a final formwork, the types of cast products that can be produced is endless. Although block type products are shown in the examples of FIGS. 10 and 12, and wall type products are shown in FIGS. 11 and 13, it should be evident that any other types of forms and associated cast products may be produced for any variety of applications. For a wall form as shown in FIG. 13 for example, the multiple form sections 10 allow for creation of a larger form, with each cast product 12 then interlocking or otherwise cooperating with an adjacent section. In this manner, individual sections of formwork 10 may be used to form a single cast product that is then positioned adjacent and integrated with other cast products to form a desired final cast product, or to make a continuous cast product, without joints between sections.

It should also be recognized that the invention is suitable to perform on site fabrication of formwork 10 at the site where the casting is to used, or for various applications. For example, formwork 10 may be fabricated at a work site for producing panels used in fabrication of retaining walls or the like.

It is also an aspect of the flexible formwork 10 of the invention that at the end of its usefulness life, it can be easily recycled. For example, the formwork 10 may be shredded down to small pellets, melted and reformed into filament. This filament would have the same characteristics of the original material, and could therefore be used to print a new formwork 10. As the material used in fabricating the formwork 10 can also be of a form that will dissolve after use or be self-degradable, it may simply dissolve or degrade over time after being used at a site, to leave the cast product in position. For this, a suitable material may be PVA (polyvinyl alcohol) plastic which is a water soluble polymer. In such an example, the form or mold 10 of the invention is 3D printed with PVA and cast similar to the other 3D printed molds, however once the cast is set, the mold is either sprayed or immersed in water until the material dissolves or disintegrates. A second water soluble material that can be used for mold making is unfired ceramics. Once again, the mold can be 3D printed and cast using a typical technique, and then water is used to disintegrate the clay to reveal the final cast product.

The formwork 10 of the invention provides the ability to use a standard or FDM styles of 3D printing, offering a new pathway for 3D printing to provide improved formwork for cast products. The products and methods of the invention allow for immediate implementation as it improves upon an existing, well-understood technique and material, precast concrete or the like. The products and methods of the invention also greatly increases design possibilities for designers, while reducing labor time and materials in the production of unique cast products. The formwork according to the invention is lightweight, easy to transport, and can be reused to cast multiple sets and then ultimately recycled and reprinted as a different form.

It should be recognized in the formwork and methods of the invention, that the present invention is not limited to the examples shown and described. The configuration described herein and the particulars thereof can be readily applied to a variety of products and applications. It is therefore understood that the above-described embodiments are illustrative of only a few of the possible specific embodiments which can represent applications of the invention. Numerous and varied other arrangements can be made by those skilled in the art without departing from the spirit and scope of the invention.

What is claimed is:

1. A system for producing a three dimensional object from a curable material comprising:
a processing system to allow input of information on the geometry of a three-dimensional object, and generating a three-dimensional image of the object, the processing system further converting the geometry of the three-dimensional image to a design of a form for casting the three dimensional object from a curable material, and converting the design of the form to a format that is compatible with a three-dimensional printer;
a three-dimensional printer for printing the three-dimensional form from a printing material, wherein the three-dimensional form includes at least one surface for engaging a curable material in a mold.

2. The system of claim 1, wherein the at least one surface is formed of a plastic material having predetermined characteristics to allow moisture to be evacuated from the mold for curing of the curable material in the mold.

3. The system of claim 1, wherein the three-dimensional printer includes a robotic arm 20 having a three-dimensional printing head associated therewith.

4. The system of claim 1, wherein the printing material is a flexible material that can be recast multiple times without damage to the form itself.

5. The system of claim 1, wherein the printing material allows transmission of moisture to evacuate moisture as the curable material cures in the form.

6. The system of claim 1, wherein the three-dimensional printer forms a pattern or ornamentation in the at least one surface of the three-dimensional form.

7. The system of claim 1, wherein the thickness of the wall forming the at least one surface is controlled to create a predetermined stiffness.

8. The system of claim 1, wherein the form includes integrated connecting portions that produce interlocking connections in the curable material, to allow multiple products produced by the form to be connected together.

9. The system of claim 1, wherein the form includes interlocking connections to allow multiple form sections to be connected to create a larger form.

10. The system of claim 1, wherein the printing material is a dissolvable material.

11. A method for molding a form for casting of a three dimensional object comprising:
converting a geometry of a three-dimensional design of a form for casting of a three dimensional object to a format that is compatible with a three-dimensional printer; printing the three-dimensional design to prepare a three-dimensional form from a printing material using the three dimensional printer.

12. The method of claim 11, wherein the three-dimensional design includes at least one wall with at least one surface with ornamentation associated therewith.

13. The method of claim 11, wherein the thickness of the at least one wall is controlled to produce a predetermined stiffness.

14. The method of claim 11, wherein the three-dimensional printer includes a robotic arm 20 having a three-dimensional printing head associated therewith.

15. A form for casting of a product comprising:
at least one wall having at least one surface for engaging a curable material in a mold, the at least one surface formed of a plastic material having predetermined characteristics to allow moisture to be evacuated from the mold for curing of the curable material in the mold or of a dissolvable material.

16. The form of claim 15, wherein form is produced from a flexible material that can be recast multiple times without damage to the form itself.

17. The form of claim 15, wherein the form includes integrated connecting portions that produce interlocking connections in a curable material molded therein, to allow multiple products produced by the form to be connected together.

18. The form of claim 15, wherein the form includes interlocking connections to allow multiple form sections to be connected to create a larger form.

19. The form of claim 15, wherein the thickness of the at least one wall forming the at least one surface is controlled to create a predetermined stiffness.

20. The form of claim 15, wherein the geometry of the form is converted to image data and the image data is converted to a format that is compatible with a three-dimensional printer, and the form is produced by three-dimensional printing.
